(19) United States
(12) Patent Application Publication
(10) Pub. No.: US 2010/0229161 A1
(43) Pub. Date: Sep. 9, 2010

(54) COMPILE METHOD AND COMPILER

(75) Inventor: Noriyasu MORI, Tokyo (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/694,657

(22) Filed: Jan. 27, 2010

(30) Foreign Application Priority Data
Mar. 4, 2009 (JP) 2009-050142

(51) Int. Cl. G06F 9/45

(52) U.S. Cl. 717/149

(57) ABSTRACT

A compile technique is provided for multicore allocation, by which a desired running performance can be achieved. The steps of analyzing a taskization directive, taskizing a specified part, and assigning a specified CPU the task are adopted for the compile technique. According to the program-to-tasks-decomposition compile technique, the multicore decomposition is performed by allocating tasks to CPUs individually while following a task decomposition directive of a main part designated by a user. When no direction is issued concerning a CPU to be allocated, the relation with a principal task is judged from the relation of invocation and the dependency, and CPU to be allocated, and then the CPU to be allocated is determined. In allocation to the CPU, an efficient multicore-task decomposition is achieved in consideration of copy and assignment of one processing to more than one CPU while figuring in the balance between processing speed and resources.

### CLAIM OF PRIORITY

The Present application claims priority from Japanese application JP 2009-050142 filed on Mar. 4, 2009, the content of which is hereby incorporated by reference into this application.

### FIELD OF THE INVENTION

The present invention relates to a compile method and a compiler, and particularly it relates to a technique for changing a program, which was described so as to execute successive processing, into a program which performs parallel processing automatically or in accordance with a direction from a programmer.

### BACKGROUND OF THE INVENTION

Multitask is a function of OS (Operating System) which allows a computer working on the OS to perform multiple processes concurrently in parallel. On a system developed for Multitask, processing is performed for each task, which is an independent unit for processing. A task is executed by invocating a kernel of a real-time OS, such as ITRON. As for ITRON, see Yuji Katori: “SuperH de manabu μITRON si-you OS (μITRON specification OS learning with SuperH)”, pp. 31-37, Denpa Shinbun-sha, Japan (2006).

In addition, a multicore chip having multiple CPU cores incorporated in one chip has been becoming popular with the advancement of semiconductor processes. As to the building of a multicore structure, see Ken Yoshinaga: “SH-2A no multicore ka to software no Taiou (Construction of a structure with SH-2A processor cores, and the software preparation therefor)”, pp. 154-163, April ed., 2008, Interface, Japan (2008).

Known as a technique for modifying a sequential-execution program into a parallel-execution one is a means by which in response to input of a directive by a programmer for directing parallelization, a computer analyses the directive using a parallelization compiler, and changes a program described so as to execute successive processing into a program which conducts parallel processing. For example, in the case of OpenMP, which is a parallelization language intended for a parallel computing machine of shared-memory type, a programmer inserts a directive for e.g. loop parallelization or variable privatization in a program, whereby a compiler performs a parallelization conversion in accordance with the direction. As for OpenMP, see “OpenMP C and C++ Application Program Interface Version 2.0”, March, 2002, at http://www.openmp.org/, provided that this is based on a result of Web search on Feb. 3, 2009.

### SUMMARY OF THE INVENTION

In a system designed for a multicore chip, two or more CPUs can each perform multitask processing. In such case, a programmer concerned needs to be conscious of which CPU to use for executing a task, and decide, for each task, CPU to be put in charge of executing the task.

For instance, in the case of transporting a sequential-execution program into a system intended for multitasking, it is required to take the steps of extracting a certain part of the sequential-execution program as a task, and activating and executing the task. In other words, it is necessary for such transportation to decompose a program into tasks, thereby to change the program into a program such that tasks are activated individually.

Further, in the case of transporting a program into a multicore system, it is required to decide CPU to be put in charge of executing each task after the program decomposition into the tasks, and then it becomes necessary to allocate the tasks to multiple cores. In addition, how to handle global variables is important for multicore systems. Depending on the way to allocate tasks, the need may arise for another CPU running a task to access the same global variable. This does not become a problem as long as the system has a common access region, and the global variable can be put in the common access region. However, there is also a system such that as a global variable is assigned to a certain CPU, another CPU running a task cannot access it. Even with a system having a common access region, in the case where only a certain CPU accesses the region for a global variable, it is general that a faster access can be made by assigning the variable to the CPU. Therefore, a judgment becomes important on which CPU (or common region) to be assigned a global variable.

In the case of transporting a sequential-execution program into a system intended for multitasking, a programmer has needed to make a judgment as described above and perform the programming manually.

Further, OpenMP, which is a parallelization language intended for a parallel computing machine of shared-memory type, has required that a programmer insert a directive for e.g. loop parallelization or variable privatization in a program, and a compiler conduct parallelization conversion in accordance with the directive.

As described above, the program's decomposition into tasks and multicore allocation of the tasks have a large impact on the running performance of the program. Even with any of the techniques described in the references cited above, a programmer has been required to make a judgment based on his or her experiences, and perform the program decomposition and task allocation manually. In short, whether or not a program prepared by the decomposition to tasks achieves a desired running performance largely depends on the skill of a programmer, and a large burden is put on the programmer to actualize of such program.

Therefore, it is an object of the invention to provide a compile method and a compiler, which enables an efficient multicore-task allocation.

The above and other objects of the invention and novel features thereof will become apparent from the description hereof and the accompanying drawings.

Of preferred embodiments of the invention herein disclosed, representative one will be outlined below.

A preferred embodiment of the invention offers a compile method and a compiler putting the compile method in practice, for which the steps of analyzing a taskization directive, arranging a specified part into a task, and assigning a specified CPU the task are adopted. According to the program-to-tasks-decomposition compile technique, a task is assigned to a CPU following a program-to-task decomposition direction in connection with an important part specified by a user. In this way, multicore decomposition is performed. If there is no direction for designating which CPU to be assigned each task, the user makes a judgment on the relevancies with principal tasks in terms of invocation and dependency and then decides the CPU to be put in charge of executing a task of interest. In assignment to CPUs, the measure of copying a process thereby to assign CPUs the same process, which is hereinafter referred to as “copy-and-assignment”, is taken into account. In this way, an efficient multicore-task allocation, in which attention is paid to the processing speed and the balance of resources, is realized.

The effect achieved by the representative embodiment is as follows in brief.

According to the invention, the multicore-task allocation can be performed efficiently.

These and other features, objects and advantages of the present invention will become more apparent from the following description when taken in conjunction with the accompanying drawings.

### BRIEF DESCRIPTION OF THE DRAWINGS

FIG. 1 is a block diagram showing an example of a computing-machine system on which a compiler in accordance with an embodiment of the invention works;

FIG. 2 is a diagram for explaining an example of a sequential-execution program, to which an attempt was made to apply a compile method in accordance with an embodiment of the invention;

FIG. 3 is a diagram for explaining an example of a program with a taskization directive, which makes an input to the program-to-task decomposition compiler in accordance with the embodiment;

FIG. 4 is a diagram for explaining an example of a taskized parallel-execution program, which makes an output of the compiler in accordance with the embodiment;

FIG. 5 is a diagram for explaining an example of the structure of processing by the program-to-task decomposition compiler in accordance with an embodiment of the invention;

FIG. 6 is a diagram for explaining an example of the program region table;

FIG. 7 is a diagram for explaining an example of the program region assignment table;

FIG. 8 is a diagram for explaining an example of the global variable assignment table;

FIG. 9 is a flow chart showing an example of the procedure for processing by the program-to-task decomposition compiler entirely;

FIG. 10 is a flow chart showing an example of the process of taskization directive analysis;

FIG. 11 is a flow chart showing an example of the process of creating relevant region's data;

FIG. 12 is a flow chart showing an example of the process of creating data concerning a candidate for program region assignment;

FIG. 13 is a flow chart showing an example of the process of deciding the program region assignment;

FIG. 14 is a flow chart showing an example of the process of creating a relevant variable;

FIG. 15 is a flow chart showing an example of the process of creating data of a candidate for variable assignment;

FIG. 16 is a flow chart showing an example of the process of deciding the variable assignment; and

FIG. 17 is a flow chart showing an example of the process of taskization conversion.

### DETAILED DESCRIPTION OF THE PREFERRED EMBODIMENTS

### 1. Summary of the Preferred Embodiments

First, preferred embodiments of the invention herein disclosed will be outlined below. In the description of the preferred embodiments, the reference characters or signs to refer to the drawings, which are accompanied with paired round brackets, only exemplify what the concepts of components or features referred to by the characters or signs contain.

[1] A compile method in accordance with an embodiment of the invention is a method which follows the steps of reading an input source code program composed of program segments into a computer device in response to supply thereof, and converting the input program into program codes executable in parallel on a parallel computing machine including a plurality of CPUs. The method includes: a step (901) of analyzing a taskization directive designating taskization-target regions in the input source code program, the taskization-target regions each composed of a part of the program segments to be run independently in parallel; and a program region assigning step (902), including deciding, based on a result of the analysis of the taskization directive, the CPU to be assigned each taskization-target region making one of the program regions, and the CPU to be assigned each non-taskization-target region not designated as one of the taskization-target regions, but composed of a part of the program segments, and making one of the program regions. The program region assigning step includes a relevant region data creating step (9021), which involves analyzing relations among the taskization-target regions and non-taskization-target regions thereby to create relevant region data. The non-taskization-target regions are assigned to the CPUs using the relevant region data.

[2] The compile method as described in [1] further includes a global variable assigning step (903) of assigning a global variable, which includes deciding the CPU to be assigned a global variable based on a result of the analysis of the taskization directive.

[3] In the compile method as described in [1], the taskization directive includes descriptions for directing tasks to be executed in parallel, and for directing allocation of the CPU to be put in charge of executing each task.

[4] In the compile method as described in [1], the relevant region data have data (46, 47) which enable identification of relations of invocations in connection with functions of the taskization-target regions and non-taskization-target regions.

[5] In the compile method as described in [2], the relevant region data hold data (48) which enable identification of relations involved with global variables' usage by the taskization-target regions and global variables' usage by the non-taskization-target regions.

[6] In the compile method as described in [1], the program region assigning step includes a copy-and-assignment step (1307, 1308), which includes copying one non-taskization-target region thereby to assign the non-taskization-target region to at least two of the CPUs.

[7] In the compile method as described in [6], the program region assigning step includes analyzing a CPU assignment condition of the program regions thereby to judge an advantage of performing the copy-and-assignment step.

[8] In the compile method as described in [7], the judgment on the advantage in the copy-and-assignment judging step is performed depending on whether or not the CPUs, to which an attempt is made to assign the non-taskization-target region, each have a room to accept the assignment in their program region, and one non-taskization-target region is assigned to the CPUs on condition that the CPUs each have such room to accept the assignment.

[9] A compiler (108) in accordance with an embodiment of the invention is a software program operable to convert an input source code program composed of program segments into program codes executable in parallel on a parallel computing machine including a plurality of CPUs. The compiler controls: a step of analyzing a taskization directive designating taskization-target regions in the input source code program, the taskization-target regions each composed of a part of the program segments to be run independently in parallel; and a program region assigning step, including deciding, based on a result of the analysis of the taskization directive, the CPU to be assigned each taskization-target region making one of the program regions, and the CPU to be assigned each non-taskization-target region not designated as one of the taskization-target regions, but composed of a part of the program segments, and making one of the program regions; the analyzing step and the program region assigning step are controlled, on condition that a computer device has read therein and been running the compiler. The program region assigning step includes a relevant region data creating step, including analyzing relations among the taskization-target regions and non-taskization-target regions thereby to create relevant region data, and assignment of the non-taskization-target regions to the CPUs is controlled using the relevant region data.

[10] The compiler as described in [9] further controls a global variable assigning step which decides the CPU to be assigned a global variable based on a result of the analysis of the taskization directive.

[11] In the compiler as described in [9], the taskization directive includes descriptions for directing tasks to be executed in parallel, and for directing allocation of the CPU to be put in charge of executing each task.

[12] In the compiler as described in [9], the relevant region data have data which enable identification of relations of invocations in connection with functions of the taskization-target regions and non-taskization-target regions.

[13] In the compiler as described in [10], the relevant region data have data which enable identification of relations involved with global variables' usage by the taskization-target regions and global variables' usage by the non-taskization-target regions.

[14] In the compiler as described in [9], the program region assigning step includes a copy-and-assignment step, which includes copying one non-taskization-target region thereby to assign the non-taskization-target region to at least two of the CPUs.

[15] In the compiler as described in [14], the program region assigning step includes a copy-and-assignment judging step, which includes analyzing a CPU assignment condition of the program regions thereby to judge an advantage of performing the copy-and-assignment step.

[16] In the compiler as described in [15], the judgment on the advantage in the copy-and-assignment judging step is performed depending on whether or not the CPUs, to which an attempt is made to assign the non-taskization-target region, each have a room to accept the assignment in their program region, and one non-taskization-target region is assigned to the CPUs on condition that the CPUs each have such room to accept the assignment.

### 2. Further Detailed Description of the Preferred Embodiments

The preferred embodiments will be described further in detail. In the description below, the case of transporting a sequential-execution program into a system intended for multitasking is taken as an example.

First, a multicore system which is a data processing system which executes a program created by a compiler in accordance with an embodiment of the invention, will be described in brief. The multicore system has a plurality of CPU cores, and a common region accessible for all the CPUs. For the sake of simplicity, it is assumed here that two CPUs, i.e. CPU1 and CPU2 are present. A task can be arranged in a program that any one of CPU1 and CPU2 will execute. Incidentally, identical tasks may be arranged in program regions of two or more CPUs respectively. Also, a CPU can invoke another task allocated to another CPU. However, it is more efficient to arrange a task in a program region of a CPU which will execute the task. All of CPUs can access a global variable placed in a shared region, however a global variable arranged in a certain CPU cannot be accessed from any other CPUs. As to an access to a global variable, CPU can access more efficiently a global variable placed in a program region of itself rather than a variable in a common region.

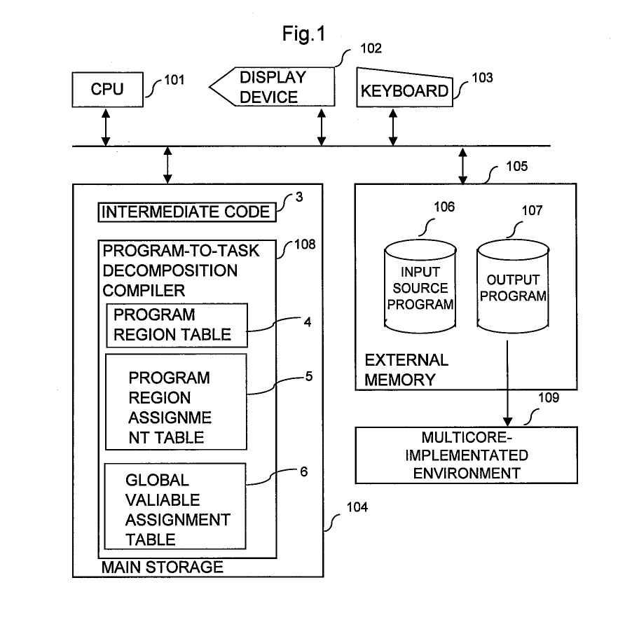

FIG. 1 is a diagram showing a configuration of a computing-machine system, on which a compiler putting a compile method in accordance with an embodiment of the invention in practice is run. The computing-machine system includes: a CPU 101; a display device 102; a keyboard 103; a main memory 104; and an external memory 105.

The CPU 101 receives a compiler-activation command from a user through the keyboard 103. A compiler-deactivation message and an error message are displayed on the display device 102. In the external memory 105, an input source program 106 and output program 107 are stored. The input source program is a source program handled as a sequential-execution program targeted for compilation. The output program 107 is a program for a multicore system, which results from the compilation of the input source program 106.

The main memory 104 holds a compiler 108, as a software program putting the compile method in practice, and stores intermediate codes 3, which is required in the course of compilation, a program region table 4, a program region assignment table 5, and a global variable assignment table 6.

The compilation step is controlled by CPU 101. That is, the CPU 101 causes the compiler 108 to run. An output program 107 produced by the compile method in accordance with the embodiment is executed in a multicore-implementated environment 109. The multicore-implementated environment 109 corresponds to the multicore system as described above. In the description below, which will be presented with reference to the drawings, the CPU 101 is assumed to be an operating entity unless otherwise stated.

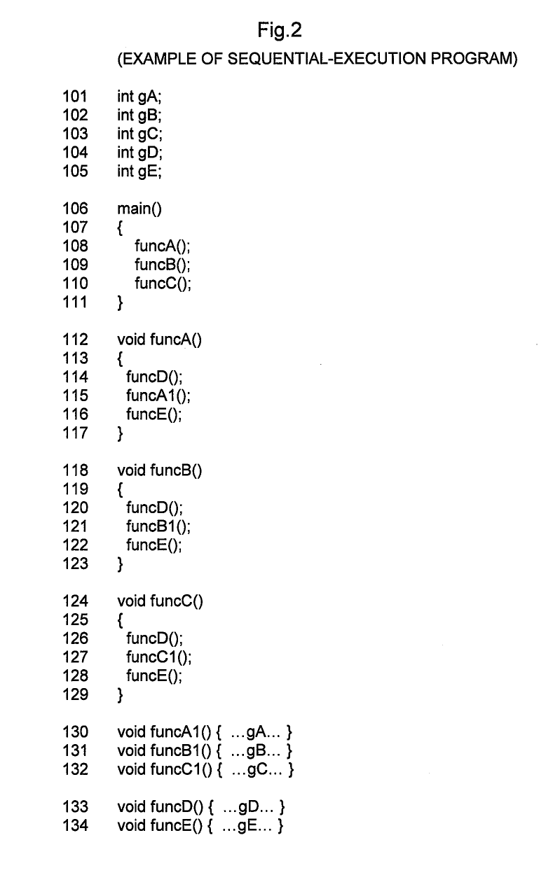

FIG. 2 shows an example of the sequential-execution program, to which an attempt is made to apply the compile method in accordance with the embodiment.

The main function in the 106th line invokes functions of funcA of the 112th line, funcB of the 118th line, and funcC of the 124th line in turn. The functions funcA, funcB and funcC invoke the functions of funcD of the 134th line and funcE of the 135th line as common functions, and in addition they invoke eigen functions of funcA1 of the 130th line, funcB1 of the 131st line, and funcC1 of the 132nd line, respectively. Further, five global variables of gA to gE are declared in the 101st to 105th lines, which are subjected to accesses from the functions funcA1 to funcC1, funcD and funcE respectively.

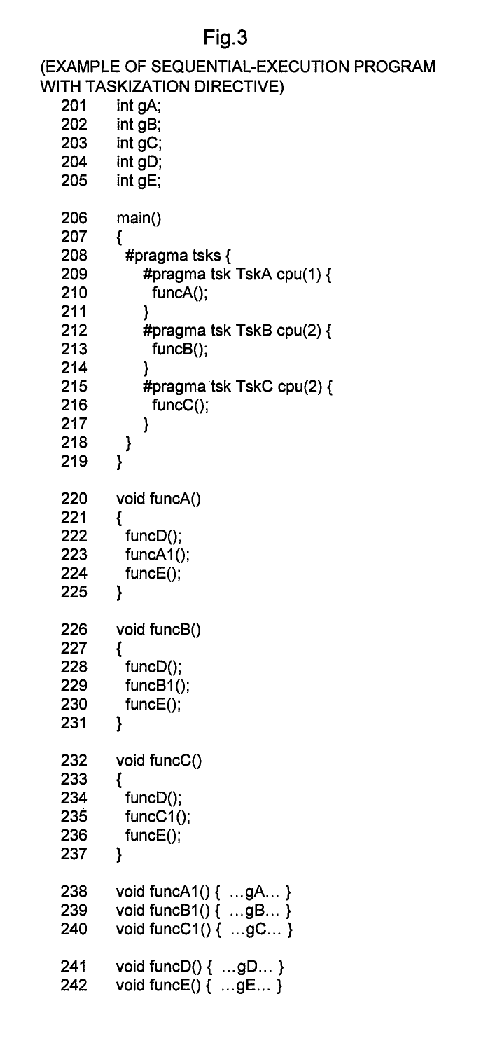

FIG. 3 shows an example of a sequential-execution program with a taskization directive, which is prepared by adding a taskization direction to the sequential program of FIG. 2. This makes an input to the program-to-task decomposition compiler 108 in accordance with the embodiment, namely the input source program 106.

The character string “#pragma tsks” in the 208th line is a statement for directing the compiler 108 to execute, as a parallel task, a portion surrounded by a pair of braces {} behind it. The character string “#pragma tsk TskA cpu (1)” in the 209th line is a statement for directing the CPU1 to execute, as an independent task TskA, a portion surrounded by a pair of braces {} behind it. The statements of the 212th and 215th lines function in the same way. Other statements are the same as those of the program shown in FIG. 2. A combination of the character string “#pragma tsks” and the portion surrounded by a pair of braces {} behind it, i.e. the description ranging from the 208th to 218th lines, serves as a taskization directive which specifies regions of tasks corresponding to program segments to be executed in parallel independently.

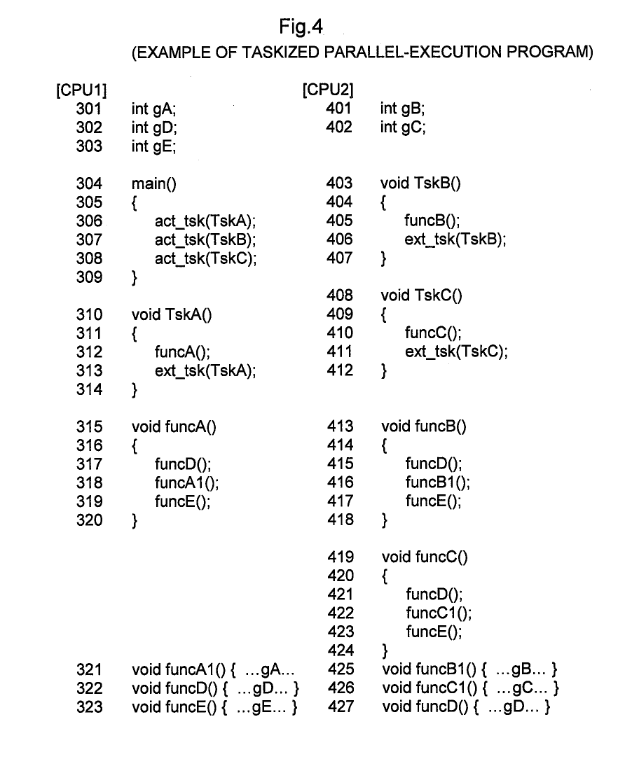

FIG. 4 shows an example of the taskized parallel-execution program after decomposition to tasks, which was gained as a result of the application of the compile method in accordance with the embodiment to the program shown in FIG. 3. The program resulting from the decomposition to tasks may be an object program or a source program. However, in the example shown in FIG. 4, the program takes on a source program form. The program resulting from the decomposition to tasks corresponds to the output program 107.

With this embodiment, the multicore environment as described above, in which such that two CPUs, namely CPU1 and CPU2, working independently of each other execute tasks, is assumed. In the example of FIG. 4, a program for CPU1 (from the 301st to 323rd lines) and a program for CPU2 (from the 401st to 427th lines) are shown.

The processing of the taskized parallel-execution program is executed activating tasks. The statements act_task of the 306th to 308th lines of FIG. 4 represent activations of tasks TskA, TskB and TskC respectively. Further, “ext_tsk(TskA)” of the 313th line represents the end of the task TskA. Likewise, “ext_tsk(TskB)” of the 406th line represents the end of the task TskB, and “ext_tsk(TskC) of the 411th line represents the end of the task TskC.

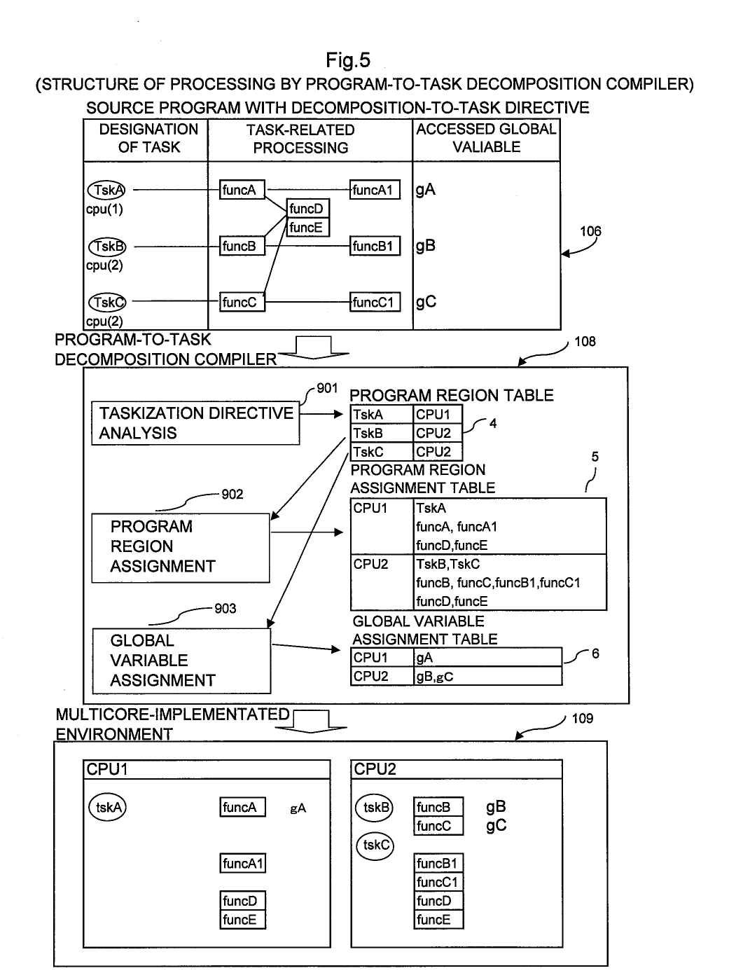

FIG. 5 shows the structure of processing by the program-to-task decomposition compiler 108 in accordance with an embodiment of the invention.

FIG. 5 presents illustration of invocations and other correspondences in connection with the source program with a program-to-task decomposition direction shown in FIG. 3. In FIG. 5, the way to designate a task, task-related processing, and the situation of access to a global variable are illustrated. However, it is noted that in the drawing, the processing structure is partially omitted for ease of understanding.

In invocations of the functions funcA, funcB and funcC, tasks are designated; the tasks are named TskA, TskB and TskC as task names. The function funcA invokes not only the eigen function funcA1, but also common functions funcD and funcE. The functions funcB and funcC are similarly arranged. Also, it is shown that the functions funcA to funcC make accesses to global variables gA to gC respectively.

The program-to-task decomposition compiler 108 is in charge of taskization directive analysis 901, program region assignment 902, and global variable assignment 903.

In taskization directive analysis 901, the source program 106 with a program-to-task decomposition direction, which is an input to the compiler, is analyzed in directive, whereby a program region table 4 is created.

In program region assignment 902, the program region assignment table 5 is created in response to input of the program region table 4; the program region assignment table decides the assignment of program regions to CPUs.

In global variable assignment 903, a global variable assignment table 6 is created in response to input of the program region table 4; the global variable assignment table decides the assignment of global variables to CPUs.

The final CPU assignment is decided based on the program region assignment table 5 and global variable assignment table 6, which is launched into a multicore-implementated environment 109.

Now, it is noted that intermediate codes 3 are referred to by almost every functioning unit and therefore, of input and output relations inside the program-to-task decomposition compiler 108, primary ones are shown in the drawing except the relations in connection with the intermediate codes 3.

The portion of the drawing, where the multicore-implementated environment 109 is illustrated, shows the assignment of CPUs. For example, it is shown that the task Tsk, functions funcA, funcA1, funcD and funcE, and the global variable gA are assigned to CPU1. As clear from the drawing, the CPUs are assigned in accordance with the program region assignment table 5 and global variable assignment table 6 produced by the program-to-task decomposition compiler 108.

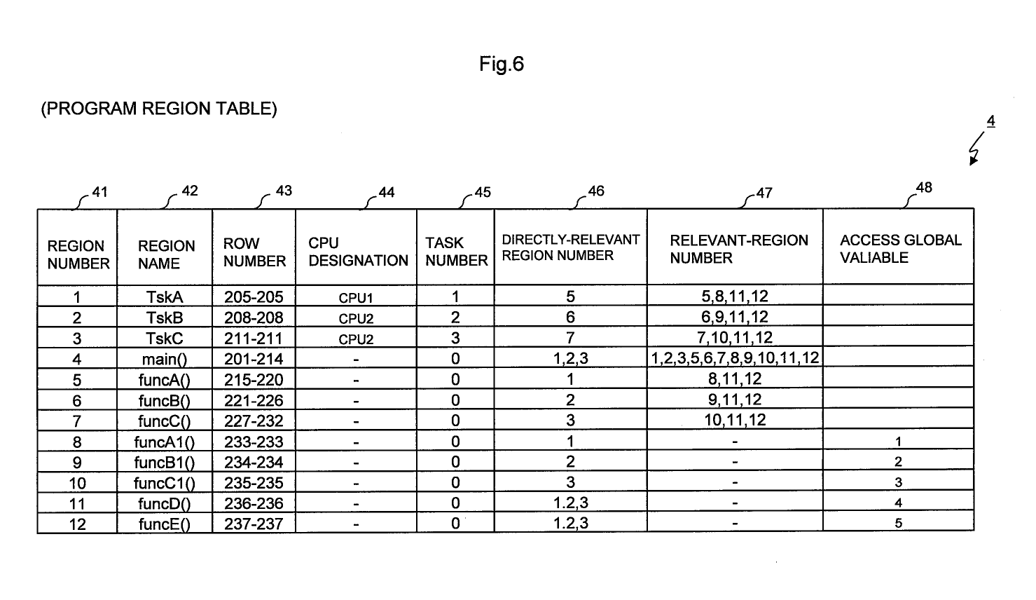

FIG. 6 shows an example of arrangement of the program region table 4 created in connection with the input program shown in FIG. 3.

The program region table 4 is a result of decomposition of an input program in accordance with the program-to-task decomposition direction, which holds data of task names and a user-designated CPU and other information.

Each of the table consists of into: a region number 41; a region name 42; a row number 43; a CPU designation 44; a task number 45; a directly-relevant region number 46; a relevant-region number 47; an access global variable 48.

As the region number 41 and region name 42, a region number assigned to a program region and its region name are stored respectively. The region name 42 is a unique name assigned to each region. As the region name 42, a task name designated by a user is entered for a region designated as a taskization target, and function names are entered for other regions.

The row number 43 represents a program region in the form of a couple of start and end row numbers of row numbers of an input source.

In the case where there is a user-designated CPU to be assigned to a program region of interest, the number of the designated CPU is stored as an item of the CPU designation 44. In this embodiment, the user-designated CPU can be designated only at the time of designating a taskization-target region. As shown in FIG. 6, the CPU designation entries are present only for taskization-target regions, which have region numbers 1 to 3 (region names TskA, TskB and TskC). As to other program regions, there is no CPU designation entry, which is represented by “-”. In short, in this example, CPU has been designated for a task in the input source program 106, and an attempt is made to perform a CPU designation optimally for a non-task, such as a function for which no CPU has been designated, as described later.

As the task number 45, a numeral allocated to a task at the time when a program region of interest is taskized is entered. However, in the case where a program region concerned is not to be taskized, the program region will be a non-taskization-target region, and “0” is entered as the task number to show that the region is not a task.

The directly-relevant region number 46 represents the relation of invocation of a program region concerned. Stored as the directly-relevant region number 46 is the region number of an invocation-target program region, which is directly invoked from the task or function of the program region. For example, the function funcA of the region #5 invokes the task TaskA of the region #1 and as such, the numerals 1 is entered in the cell of the directly-relevant region number 46 involved with the function funcA.

The relevant-region number 47 represents the relation of invocation of a program region. In each cell for the relevant-region number 47, the region numbers of the program regions of invocation sources involved with the task or function of the corresponding program region are all stored. For instance, the task TskA of the region #1 directly invokes the function funcA (region #5), and indirectly invokes the functions funcA1, funcD and funcE, which are invoked by the function funcA. Therefore, the numbers 5, 8, 11 and 12 are entered in the cell for the relevant-region number of the task TskA.

In each cell for the access global variable 48, information of a global variable accessed by the task or function of the corresponding program region is stored. Now, it is noted that the global variables are represented by variable numbers in the global variable assignment table 6. For example, the numeral “1” in the cell of the access global variable involved with the region #8 shows that the function funcA1 of the region #8 can access the global variable gA of the variable #1.

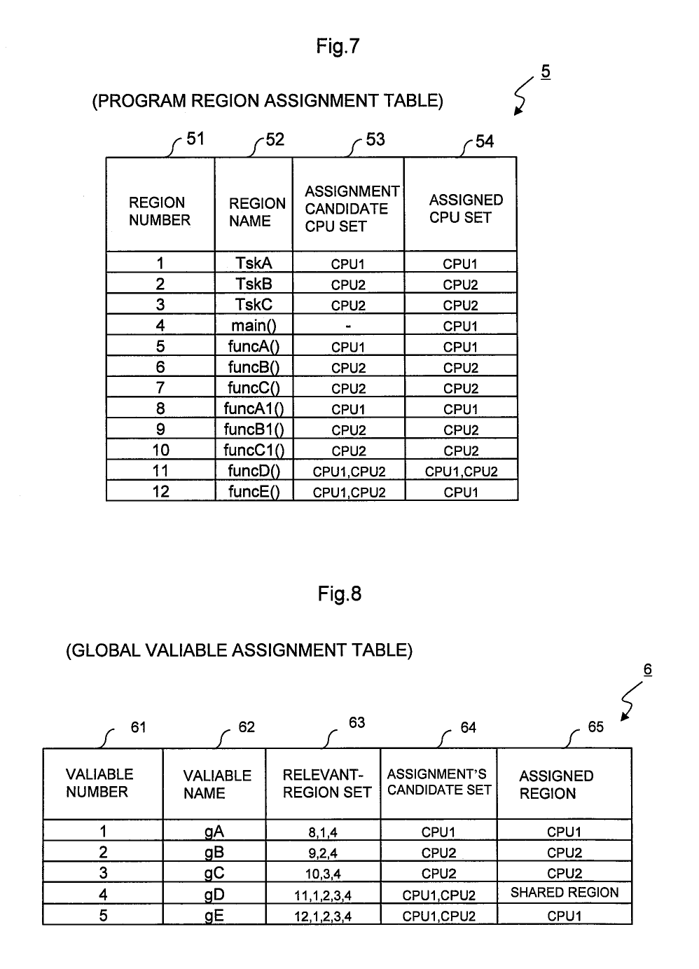

FIG. 7 shows an example of the program region assignment table 5 created in connection with the input program shown in FIG. 3.

The program region assignment table 5 is referred to in assignment of program regions to individual CPUs described with reference to FIG. 6. Each entry of the table consists of: a region number 51; a region name 52; an assignment candidate CPU set 53; and an assigned CPU set 54. The region number 51 and region name 52 are a numeral assigned to each program region, and its name, which coincide with the region number 41 and region name 42 of FIG. 6.

The assignment candidate CPU set 53 shows a candidate CPU to be possibly assigned each program region, which is derived based on the user-designated CPU and the relation of invocation of the program region by the program-to-task decomposition compiler. It is seen that in the example of FIG. 7, the function funcD of the region #11 declares CPU1 and CPU2 as its candidate CPUs for assignment.

The assigned CPU set 54 represents a CPU each program region is assigned to, showing what CPU the program-to-task decomposition compiler finally selects, as the CPU to be assigned the program region, from the assignment candidate CPU set 53. It is seen that in the example of FIG. 7, the candidate CPUs for assignment of the function funcE of the region #12 are CPU1 and CPU2. However the decision that the program region be assigned to only CPU1 is made.

FIG. 8 shows an example of the global variable assignment table 6 created in connection with the input program shown in FIG. 3.

The global variable assignment table 6 is referred to in assignment of global variables, which arise in the program, to individual CPUs. Each entry of the table consists of: a variable number 61; a variable name 62; a relevant-region set 63; an assignment candidate set 64; and an assigned region 65. Stored as the variable number 61 and variable name 62 are a variable numeral assigned to each global variable, and its variable name respectively. The relevant-region set 63 shows the number of a program region from which an access to a global variable concerned may be made in the form of a set of program region numbers.

For example, the table shows the variable gA of the variable #1 may be accessed in response to invocations in the program region #8 (funcA1), #1 (TskA) and #4 (main). Incidentally, a direct access can be made from only the program region #8 (funcA1). However, the program region #8 (funcA1) may be invoked from the program region #1 (TskA) and #4 (main). This is why the relevant-region set as shown in FIG. 8 is entered in the cell for the variable #1.

The assignment candidate set 64 shows a candidate CPU to be possibly assigned each global variable, which is derived based on the access global variable and the relation of invocation of a program region of program region table 4 by the program-to-task decomposition compiler. It is seen that in the example of FIG. 8, the candidate CPUs for assignment of the variable gE of the variable #5 are CPU1 and CPU2.

The assigned region 65 represents a CPU each global variable is assigned to, showing what CPU the program-to-task decomposition compiler finally selects, as the CPU to be assigned the global variable, from the assignment candidate set 64. It is seen that in the example of FIG. 8, assignment candidates for the global variable gE of the variable #5 are CPU1 and CPU2, however the decision that the global variable be assigned to CPU1 is made.

Now, the procedure for processing by the program-to-task decomposition compiler, which creates and refers to the tables, and achieves the decomposition to tasks, will be described below.

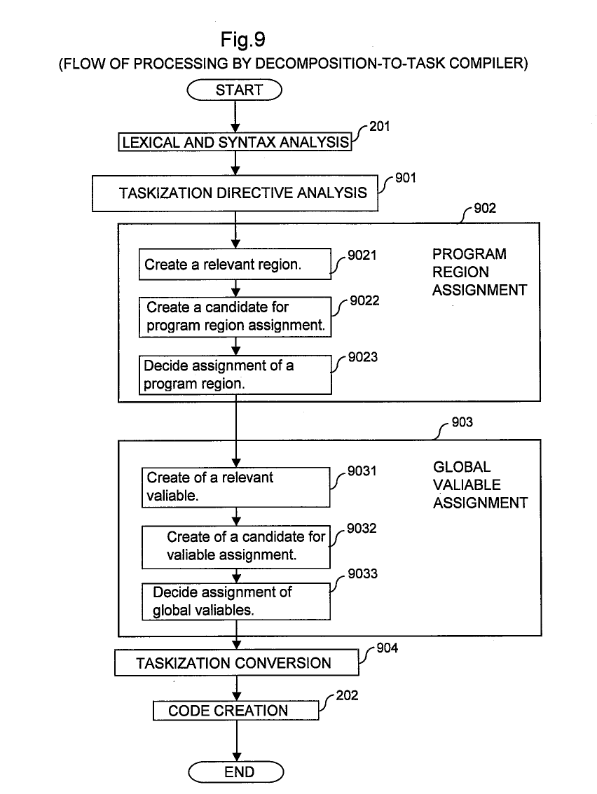

FIG. 9 shows an example of the procedure for processing by the program-to-task decomposition compiler entirely. In lexical and syntax analysis 201, the program is analyzed in lexical and syntax and is translated to intermediate codes 3 in response to input of the input source program 106.

In analyzing a taskization directive 901, a program region table 4 is created in response to input of the intermediate codes 3, which is a result of the decomposition to program regions in accordance with the taskization directive.

In assigning program regions 902, a program region assignment table 5, which decides assignments of program regions to CPUs is created in response to input of the intermediate codes 3 and program region table 4. The program region assignment 902 includes the steps of: creating a relevant region 9021; creating a candidate for program region assignment 9022; and deciding assignment of the program regions 9023.

In assigning global variables 903, the global variable assignment table 6, which decides assignment of global variables to CPUs, is created in response to input of the intermediate codes 3 and global variable table. The global variable assignment 903 includes: creating a relevant variable 9031; creating a candidate for variable assignment 9032; and deciding assignment of the global variables 9033.

In taskization conversion 904, a region designated as a taskization target is converted to a task form, in response to input of the intermediate codes 3, program region table 4, program region assignment table 5 and global variable assignment table 6, and then the intermediate codes are assigned to CPUs in accordance with the program region assignment table 5 and global variable assignment table 6.

In creating codes 202, the intermediate codes are converted, in format, to a final output program 107 (an object program or a source file for a multicore-implementated environment.

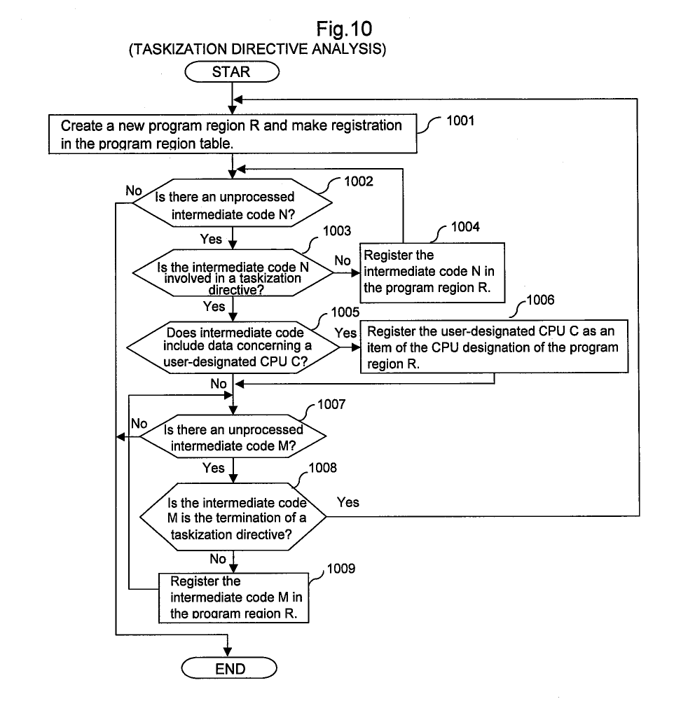

FIG. 10 is a flowchart showing an example of the procedure for processing of taskization directive analysis, which corresponds to the taskization directive analysis 901 of FIG. 9.

In Step 1001, a new program region R is created, and registered in the program region table. Then, it is checked whether or not an unprocessed intermediate code N is present (Step 1002). If not, the processing is terminated. If an unprocessed intermediate code is present, Step 1003 and subsequent steps are performed. In Step 1003, a judgment is made on whether or not the unprocessed intermediate code N is of a taskization directive. If not so, the code N is registered in the program region R (Step 1004), and then the compiler goes back to Step 1002 for processing another unprocessed intermediate code. If in Step 1003, the unprocessed intermediate code N is judged to be involved in a taskization directive, a judgment is made on whether or not the unprocessed intermediate code N includes data concerning a user-designated CPU C (Step 1005). If the unprocessed intermediate code N is judged to include such data, the user-designated CPU C is registered as an item of the CPU designation 44 of the program region R (1006), and then the compiler goes to Step 1007. In Step 1007, a judgment is made on whether or not there is a subsequent unprocessed intermediate code M. If not, the processing is terminated. If there is a subsequent unprocessed intermediate code M, a judgment is made on whether or not the unprocessed intermediate code M corresponds to the termination of the taskization directive (Step 1008). If so, the compiler goes back to Step 1001, and engages in the processing of a subsequent program region.

If the unprocessed intermediate code M is not the termination of the taskization directive, the unprocessed intermediate code M is registered in the program region R (Step 1009). Then, the compiler goes back to Step 1007, and continuously scans a subsequent intermediate code.

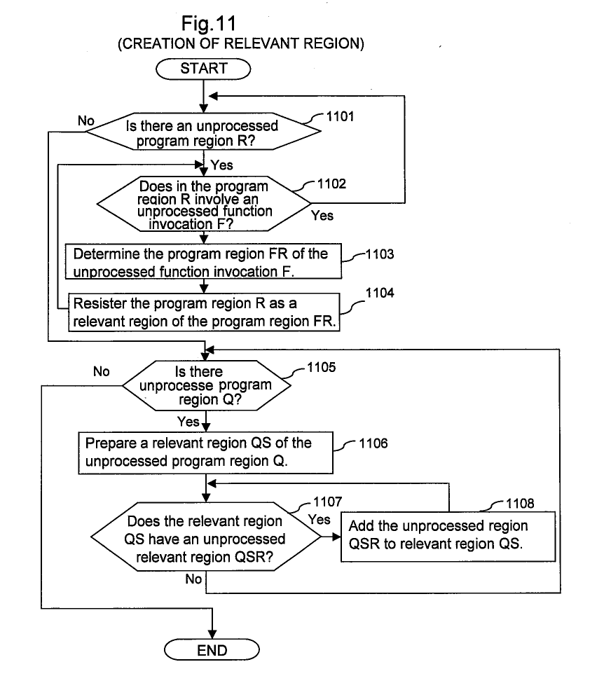

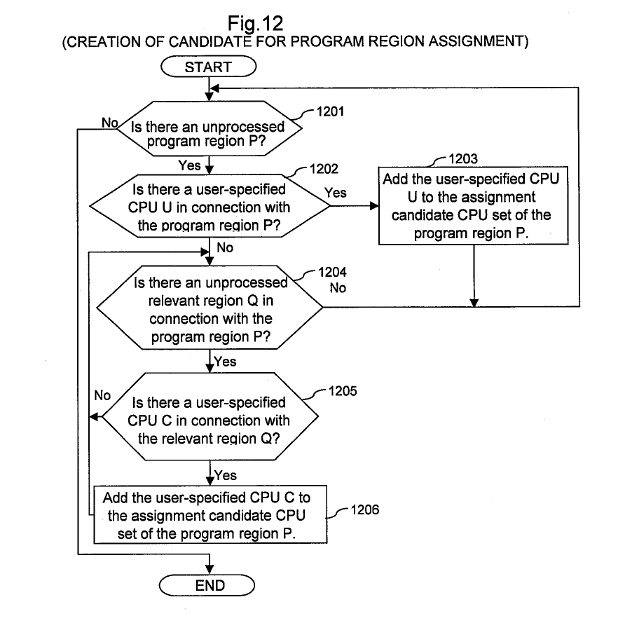

FIG. 11 is a flow chart showing an example of the procedure for creating relevant region's data, which corresponds to the relevant region's data creation 9021 of FIG. 9.

First, the program region table is scanned while checking whether or not an unprocessed program region R is present (Step 1101). If an unprocessed program region R is present, a portion of the intermediate codes 3 corresponding to the program region R is checked and judged on whether or not an unprocessed function invocation F is involved therein (Step 1102). If an unprocessed function invocation F is involved, the program region FR of the unprocessed function invocation F is determined from the program region table (Step 1103). Then, the program region R is registered as the relevant region number of the program region FR (Step 1104). The above steps will be repeated until the judgment that there is no unprocessed function invocation is made in Step 1102. In such case, the compiler goes back to Step 1101 and moves into the scan of a subsequent program region. After the scan has been finished in all the program regions, the judgment that there is no unprocessed program region is made in Step 1101, and the compiler goes to Step 1105.

In Step 1105, the program region table is scanned again, whereby a judgment is made on whether or not another unprocessed program region Q is present. If such program region Q is present, a relevant region QS of the unprocessed program region Q (which has been registered in Steps 1101 to 1104) is prepared, and a judgment is made on whether or not the relevant region QS has an unprocessed relevant region QSR (Step 1107). If such unprocessed relevant region QSR is present, the unprocessed relevant region QSR is added to the relevant region QS of the unprocessed program region Q. The addition is repeated until the judgment that there is no unprocessed relevant region is made in Step 1107. Then, the compiler goes back to Step 1105, and moves into the scan of a subsequent program region. After the completion of scan of all the program regions, the judgment of Step 1105 is made, and then the relevant-region creation 9021 is terminated.

According to the processing described with reference to FIG. 11, all of relevant regions invoked from a certain program region (including an invocation target region invoked from the certain program region and an region invoked from the target region) can be determined.

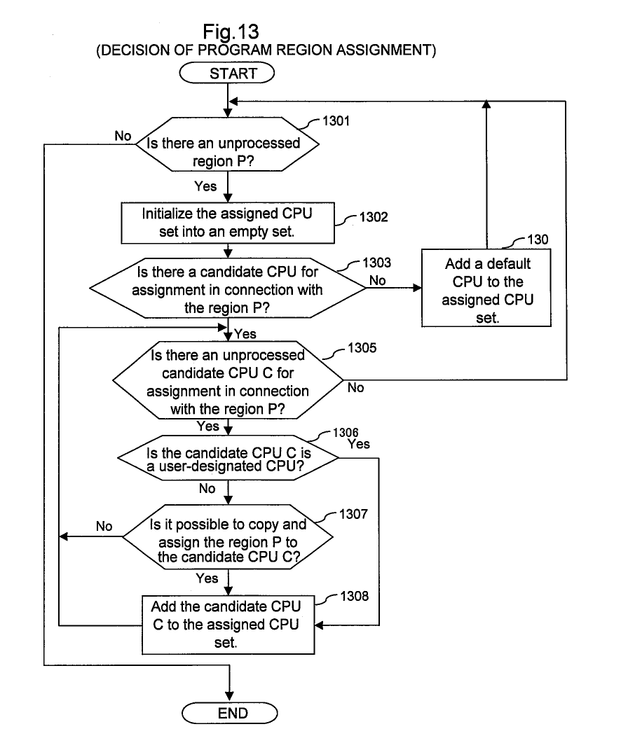

FIG. 12 is a flow chart showing an example of the procedure for creating data concerning a candidate for program region assignment, which corresponds to the program region assignment candidate's data creation 9022 of FIG. 9.

First, the program region table is scanned while it is checked whether or not an unprocessed program region P is present (Step 1201). If such program region P is present, a judgment is made on whether or not there is a user-designated CPU U in connection with the unprocessed program region P (Step 1202). If a user-designated CPU U is present, data of the user-designated CPU U is added to the assignment candidate CPU set of the program region P (Step 1203). After that, the compiler goes back to Step 1201, a subsequent program region is processed. If a user-designated CPU U is not present, it is checked whether or not there is an unprocessed relevant region Q in connection with the program region P (Step 1204). If there is such unprocessed relevant region Q, it is checked whether or not there is a user-designated CPU in connection with the relevant region Q (Step 1205). If the relevant region Q has such user-designated CPU C, data of the user-designated CPU C is added to the assignment candidate CPU set of the program region P (Step 1206). Then the compiler goes back to Step 1204, and performs processing for a subsequent relevant region. The Steps 1204-1206 are repeated until an unprocessed relevant region is not found. After the processing for all of relevant regions of the program region P has been finished, the compiler goes back to Step 1201, and engages in the processing of a subsequent program region. After the completion of processing of all the program regions, the result of the judgment of Step 1201 becomes No, and then all the steps are finished.

According to the processing described with reference to FIG. 12, it is possible to check, in the presence of a user-designated CPU, all of relevant regions of a certain program region.

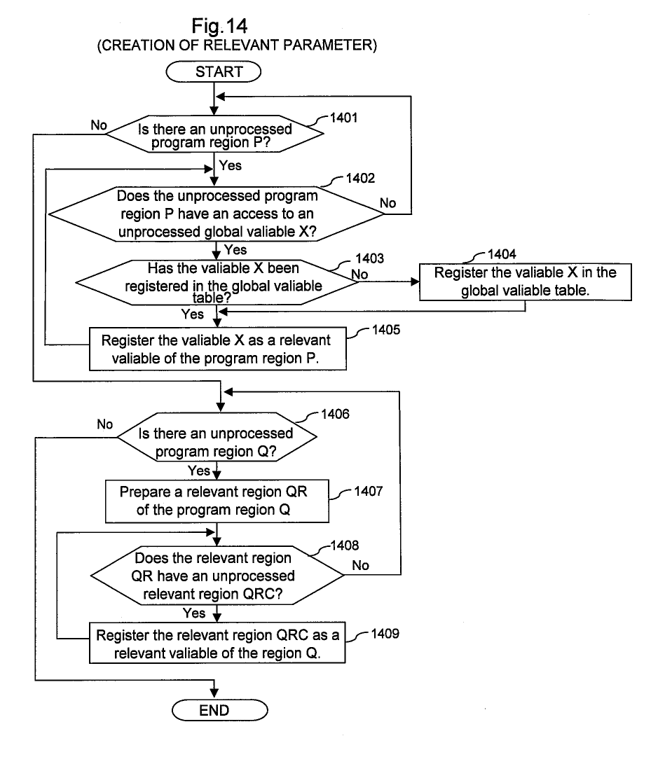

FIG. 13 is a flow chart showing an example of the procedure for deciding the program region assignment, which corresponds to the program region assignment decision 9023 of FIG. 9.

First, the program region table is scanned while checking whether or not an unprocessed program region P is present (Step 1301). If such program region P is present, the assigned CPU set of the program region P is initialized into an empty set (Step 1302). Next, a judgment is made on whether or not there is a candidate CPU for assignment in connection with the unprocessed program region P (Step 1303). If not, a default-assignment CPU is added to the assigned CPU set of the program region P (Step 1304). Then, the compiler goes back to Step 1301 and engages in the processing of a subsequent program region. If there is a candidate CPU for assignment in connection with the unprocessed program region P, a judgment is made on whether or not there is an unprocessed candidate CPU C for assignment in connection with the program region P (Step 1305). If such unprocessed candidate CPU C is present, it is checked whether or not the unprocessed candidate CPU C for assignment is a user-designated CPU (Step 1306). If the unprocessed candidate CPU C for assignment is a user-designated CPU, the compiler goes to Step 1308, and adds data of the unprocessed candidate CPU C to the assigned CPU set. Then, the compiler goes back to Step 1305, and engages in the processing of a subsequent candidate CPU for assignment. If the unprocessed candidate CPU C for assignment is not a user-designated CPU, it is checked whether or not the unprocessed program region P can be copied and assigned to the candidate CPU C for assignment, i.e. whether or not the candidate CPU C for assignment can be assigned a program consisting of the unprocessed program region P (Step 1307). If such copy and assignment is judged to be possible, the compiler goes to Step 1308, and adds the candidate CPU C to the assigned CPU set. However, if the copy and assignment is not allowed, the assignment to the candidate CPU C is abandoned. Then, the compiler goes back to Step 1305, and engages in the processing of another candidate CPU for assignment. After the completion of processing of all the candidate CPUs for assignment, the result of the judgment in Step 1305 becomes “No”. Then, the compiler goes back to Step 1301, and engages in the processing of a subsequent program region. After the completion of processing of all the program regions to be handled, the result of the judgment in Step 1301 becomes ‘No”. Then, all the steps are terminated.

According to the process described with reference to FIG. 13, the assigned CPU set, which is a set of CPUs to be assigned to individual program regions, is decided from the assignment candidate CPU set (one program region can be assigned to more than one CPU). In this way, a program region assignment table is created, which makes possible to assign CPU a relevant program region in accordance with CPU assignment designated by a user concerning a program region.

Now, it is noted that this embodiment based on the following assumption: it is always faster to copy and assign a program region. In other words, putting a non-task process to be executed by two or more CPUs individually in a program region of each CPU can contribute to speed-up of data processing by the CPUs. For this reason, Step 1307 is arranged so that program regions are checked in size, and the judgment is made depending on whether or not a CPU of interest still has a room to accept assignment. Whether or not a CPU of interest still has a room to accept assignment is judged taking into account whether or not there is an unoccupied capacity in a program region for the CPU concerned.

FIG. 14 is a flow chart showing an example of the procedure for creating a relevant variable, which corresponds to the relevant variable data creation 9031 of FIG. 9.

First, the program region table 4 is scanned while it is checked whether or not an unprocessed program region P is present (Step 1401). If such program region P is present, a judgment is made on whether or not the program region P has an access to an unprocessed global variable X (Step 1402). If the program region P is judged to have such access, it is checked whether or not the global variable X has been already registered in the global variable table (Step 1403). If not, the global variable X is registered (Step 1404). Thereafter, the global variable X is registered as a relevant variable of the program region P (Step 1405). Then the compiler goes back to Step 1402, and engages in the processing of a subsequent global variable. After having finished the processing of all the global variables, the compiler goes back to Step 1401 and engages in the processing of a subsequent program region. After the completion of processing of all the program regions, the result of the judgment in Step 1401 becomes “No”. Then, the compiler goes to Step 1406 and subsequent steps.

In Step 1406, the program region table 4 is scanned again while it is checked whether or not an unprocessed program region Q is present. If such program region Q is present, a relevant region QR of the unprocessed program region Q is prepared (Step 1407). Then, it is checked whether or not the relevant region QR has an unprocessed relevant region QRC (Step 1408). If there is such relevant region QRC, the relevant region QRC is registered as a relevant variable of the program region Q (Step 1409). After the completion of processing of all the relevant regions, the result of the judgment in Step 1408 becomes “No”. Then, the compiler goes to Step 1406, and engages in the processing of a subsequent program region. In addition, after completion of processing of all the program regions, the result of the judgment in Ste 1406 becomes “No”. Then, all the steps are finished.

According to the process described with reference to FIG. 14, data concerning relevant variables covering global variable accesses of all the relevant regions of a certain program region can be created.

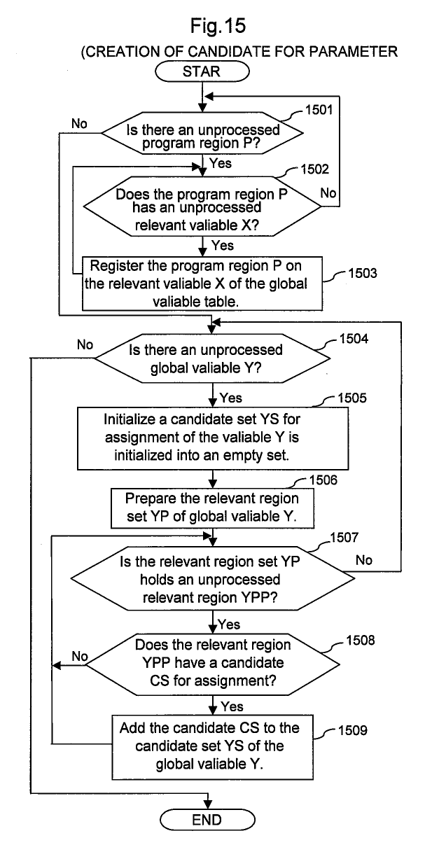

FIG. 15 is a flow chart showing an example of the procedure for creating data of a candidate for variable assignment, which corresponds to the creation of data of a candidate for variable assignment 9032 of FIG. 9.

First, the program region table 4 is scanned while it is checked whether or not an unprocessed program region P is present (Step 1501). If such program region P is present, a judgment is made on whether or not the program region P has an unprocessed relevant variable X (Step 1502). If the program region P has such relevant variable X, the program region P is registered in an entry of the variable X in the global variable table (Step 1503). After the completion of processing of all the relevant functions, the result of the judgment in Step 1502 becomes “No”. Then, the compiler goes back to Step 1501 and engages in the processing of a subsequent program region. The above steps are executed on all the program regions, whereby global variable access conditions concerning all the program regions are registered in the global variable table. After that, the step 1504 and subsequent steps are conducted.

In Step 1504, the global variable table is scanned while it is checked whether or not an unprocessed global variable Y is present. If there is such global variable Y, the assignment candidate set YS of the global variable Y is first initialized into an empty set (Step 1505). Thereafter, the relevant variable set YP of the global variable Y is prepared (Step 1506). Then, a judgment is made on whether or not there is an unprocessed relevant region YPP in connection with the relevant variable set YP (Step 1507). If there is such relevant region YPP, it is checked whether or not a candidate CS for assignment in connection with the relevant region YPP is present, with reference to a corresponding entry of the program region table 4 (Step 1508). If such candidate CS for assignment is present, the candidate CS is added to the assignment candidate set YS of the global variable Y. Then, the compiler goes back to Step 1507, and engages in the processing of a subsequent relevant region. After the completion of processing of all the relevant regions, the result of the judgment in Step 1507 becomes “No”. Then, the compiler goes back to Step 1504 and engages in the processing of a subsequent global variable. When the processing of all the global variables is finished. Then, all the steps are completed.

According to the process described with reference to FIG. 15, it is possible to create, for each global variable, a set of candidates for variable assignment, which covers program regions having accesses to the global variable.

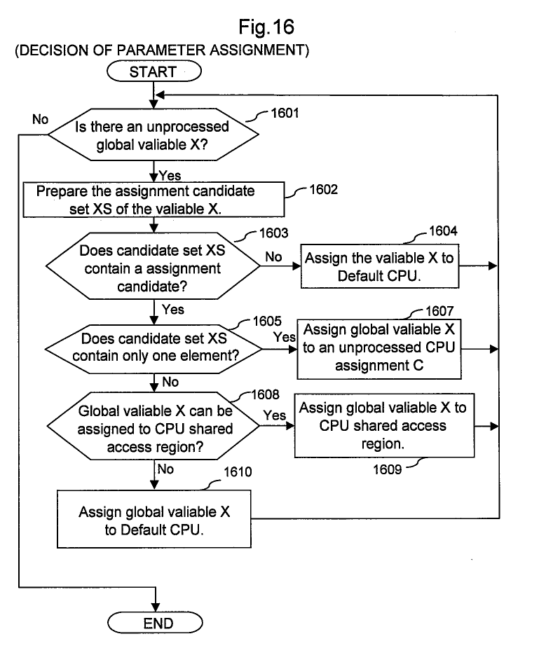

FIG. 16 is a flow chart showing an example of the procedure for deciding the variable assignment, which corresponds to the variable assignment decision 9033 of FIG. 9.

First, the global variable table is scanned while it is checked whether or not an unprocessed global variable X is present (Step 1601). If such global variable is present, the assignment candidate set XS of the global variable X is prepared (Step 1602). Next, it is checked whether or not an assignment candidate is included in the assignment candidate set XS (Step 1603). If not, the global variable X is assigned to a default CPU (Step 1604). Then, the compiler goes back to Step 1601, and engages in the processing of a subsequent global variable. If an assignment candidate is included in the assignment candidate set XS, it is checked whether or not the assignment candidate set XS is constituted by only one element C (Step 1605). If the assignment candidate set XS is constituted by only one element, the global variable X is assigned the element C (Step 1607). Then, the compiler goes back to Step 1601, and engages in the processing of a subsequent global variable. If the assignment candidate set XS is constituted by more than one element, it is checked whether or not it is possible to assign the unprocessed global variable X to a CPU shared access region (Step 1608). If possible, the global variable X is assigned to the CPU shared access region (Step 1609). Then, the execution of the compiler goes to Step 1601 and engages in the processing of a subsequent assignment candidate. If not, the global variable X is assigned to a default CPU (Step 1610). The compiler goes back to Step 1601, and engages in the processing of a subsequent global variable. After the completion of all the global variables, the result of the judgment in Step 1601 becomes “No”. Then, all the steps are finished.

According to the process described with reference to FIG. 16, a global variable assignment table is created, which makes possible to efficiently assign CPU a relevant global variable in accordance with CPU assignment designated by a user concerning a program region.

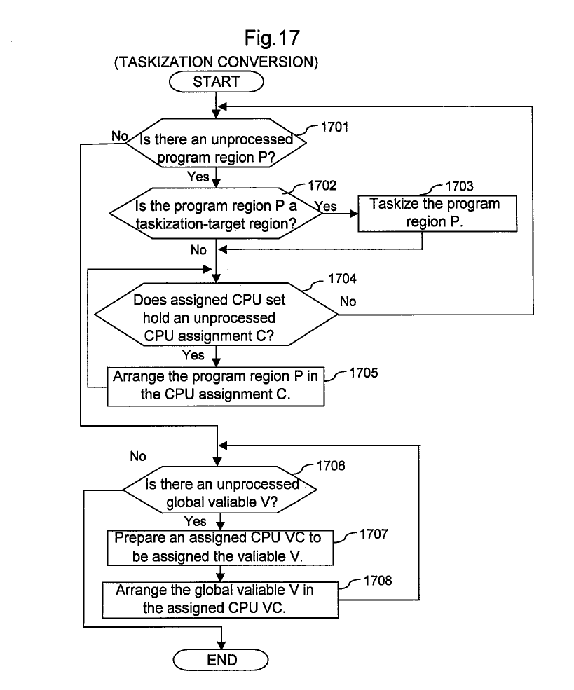

FIG. 17 is a flow chart showing an example of the procedure for taskization conversion, which corresponds to the taskization conversion 904 of FIG. 9.

First, the program region table is scanned while it is checked whether or not an unprocessed program region P is present (Step 1701). If such program region is present, it is checked whether the program region P is a taskization-target region (Step 1702). If the program region P is a taskization-target region, the program region P is converted into a task (Step 1703). If not, the process flow proceeds Step 1704 directly. In Step 1704, it is checked whether or not an unprocessed CPU assignment C is included in the CPU assignment set of the program region P. If an unprocessed CPU assignment C is included, the program region P is arranged in the unprocessed CPU assignment C (Step 1705). After the completion of these steps performed on all of CPU assignments, the result of the judgment in Step 1704 becomes “No”. Then, the compiler goes to Step 1701, and engages in the processing of a subsequent program region. After the completion of the steps performed on all the program regions, the result of the judgment in Step 1701 becomes “No”. Then, the compiler goes to Step 1706.

In Step 1706, the global variable table is scanned while it is checked whether or not an unprocessed global variable V is present. If such global variable V is present, an assigned CPU of the unprocessed global variable V, which is to be assigned the global variable V, is prepared and labeled “VC” (Step 1707), and then the global variable V is arranged for the assigned CPU VC (Step 1708). After the completion of the steps performed on all the global variables, the result of the judgment in Step 1706 becomes “No”. Then, all the steps are finished.

According to the process described with reference to FIG. 17, the taskization conversion in accordance with the program region assignment table and global variable assignment table is performed, whereby intermediate codes 3 are produced. In this way, it becomes possible to organize a taskization conversion object or a source program.

According to the compile method as described above, an efficient multicore-task allocation taking into account the balance between the processing speed and resources can be achieved in terms of the allocation to CPUs.

The compile method as described above can be applied for the purpose of extracting more than one independent processing program from an existing program with safety while ensuring that neither an interference owing to an access to a global variable nor a mutual dependency between process steps is caused.

The invention made by the inventor has been described above based on the preferred embodiments thereof. However, it is not limited to the embodiments. It is obvious that various changes and modifications may be made without departing from the scope of the invention.

The sequential-execution program and tasks associated therewith, and the sequential-execution program with direction, which are shown in FIGS. 2 and 3, are just examples. The invention can be applied to various software programs. The case where each task to assign to which CPU is uniquely designated in advance in accordance with a taskization directive has been described. However, such designation may be arranged so that the CPU to be assigned each task may be decided taking into account the amount of data processed by the task, and its relation with a resource. In any case, which CPU to be assigned a non-taskized region that is a program segment and not designated as a task region by a taskization directive is decided as a result of the compile processing by the compiler.

As described above, a compile method and compiler in accordance with the embodiments of the invention are intended for multicore task allocation and can achieve, by just directing a program-to-task decomposition for multicore, an efficient program-to-task decomposition of an important portion of a program in which the result of analysis by the compiler is leveraged. Thus, the multicore-task allocation can be performed efficiently.

Further, in accordance with an embodiment of the invention, it is possible to provide a compiler contributing to the actualization of a compile method for multicore allocation, by which a desired running performance can be achieved readily.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A compile method which follows the steps of reading an input source code program composed of program segments into a computer device in response to supply thereof, and converting the input program into program codes executable in parallel on a parallel computing machine including a plurality of CPUs, the method comprising:
a step of analyzing a taskization directive designating taskization-target regions in the input source code program, the taskization-target regions each composed of a part of the program segments to be run independently in parallel; and
a program region assigning step, including deciding, based on a result of the analysis of the taskization directive, the CPU to be assigned each taskization-target region making one of the program regions, and the CPU to be assigned each non-taskization-target region not designated as one of the taskization-target regions, but composed of a part of the program segments, and making one of the program regions,
wherein the program region assigning step includes a relevant region data creating step, including analyzing relations among the taskization-target regions and non-taskization-target regions thereby to create relevant region data, and
the non-taskization-target regions are assigned to the CPUs using the relevant region data.

2. The compile method in accordance with claim 1, further comprising a global variable assigning step of assigning a global variable, which includes deciding the CPU to be assigned a global variable based on a result of the analysis of the taskization directive.

3. The compile method in accordance with claim 1, wherein the taskization directive includes descriptions for directing tasks to be executed in parallel, and for directing allocation of the CPU to be put in charge of executing each task.

4. The compile method in accordance with claim 1, wherein the relevant region data keep data which enable identification of relations of invocations in connection with functions of the taskization-target regions and non-taskization-target regions.

5. The compile method in accordance with claim 2, wherein the relevant region data hold data which enable identification of relations involved with global variables' usage by the taskization-target regions and global variables' usage by the non-taskization-target regions.

6. The compile method in accordance with claim 1, wherein the program region assigning step includes a copy-and-assignment step, which includes copying one non-taskization-target region thereby to assign the non-taskization-target region to at least two of the CPUs.

7. The compile method in accordance with claim 6, wherein the program region assigning step includes a copy-and-assignment judging step, which includes analyzing a CPU assignment condition of the program regions thereby to judge an advantage of performing the copy-and-assignment step.

8. The compile method in accordance with claim 7, wherein the judgment on the advantage in the copy-and-assignment judging step is performed depending on whether or not the CPUs, to which an attempt is made to assign the non-taskization-target region, each have a room to accept the assignment in their program region, and one non-taskization-target region is assigned to the CPUs on condition that the CPUs each have such room to accept the assignment.

9. A compiler operable to convert an input source code program composed of program segments into program codes executable in parallel on a parallel computing machine including a plurality of CPUs, comprising:
a function of controlling
a step of analyzing a taskization directive designating taskization-target regions in the input source code program, the taskization-target regions each composed of a part of the program segments to be run independently in parallel, and
a program region assigning step, including deciding, based on a result of the analysis of the taskization directive, the CPU to be assigned each taskization-target region making one of the program regions, and the CPU to be assigned each non-taskization-target region not designated as one of the taskization-target regions, but composed of a part of the program segments, and making one of the program regions,
wherein the analyzing step and the program region assigning step are controlled, on condition that a computer device has read therein and been running the compiler,
the program region assigning step includes a relevant region data creating step, including analyzing relations among the taskization-target regions and non-taskization-target regions thereby to create relevant region data, and
assignment of the non-taskization-target regions to the CPUs is controlled using the relevant region data.

10. The compiler in accordance with claim 9, further comprising:
a function of controlling a global variable assigning step which decides the CPU to be assigned a global variable based on a result of the analysis of the taskization directive.

11. The compiler in accordance with claim 9, wherein the taskization directive includes descriptions for directing tasks to be executed in parallel, and for directing allocation of the CPU to be put in charge of executing each task.

12. The compiler in accordance with claim 9, wherein the relevant region data have data which enable identification of relations of invocations in connection with functions of the taskization-target regions and non-taskization-target regions.

13. The compiler in accordance with claim 10, wherein the relevant region data have data which enable identification of relations involved with global variables' usage by the taskization-target regions and global variables' usage by the non-taskization-target regions.

14. The compiler in accordance with claim 9, wherein the program region assigning step includes a copy-and-assignment step, which includes copying one non-taskization-target region thereby to assign the non-taskization-target region to at least two of the CPUs.

15. The compiler in accordance with claim 14, wherein the program region assigning step includes a copy-and-assignment judging step, which includes analyzing a CPU assignment condition of the program regions thereby to judge an advantage of performing the copy-and-assignment step.

16. The compiler in accordance with claim 15, wherein the judgment on the advantage in the copy-and-assignment judging step is performed depending on whether or not the CPUs, to which an attempt is made to assign the non-taskization-target region, each have a room to accept the assignment in their program region, and one non-taskization-target region is assigned to the CPUs on condition that the CPUs each have such room to accept the assignment.
